(19) United States
(12) Patent Application Publication
(10) Pub. No.: US 2015/0287995 A1
(43) Pub. Date: Oct. 8, 2015

(54) ELECTRODE WITH DECREASED CONTACT RESISTANCE

(71) Applicant: E I DU PONT DE NEMOURS AND COMPANY, Wilmington, DE (US)

(72) Inventors: KOSTANTINOS KOURTAKIS, Media, PA (US); Mark Gerrit Roelofs, Earleville, MD (US); Gerard Joseph Grier, Wilmington, DE (US)

(21) Appl. No.: 14/645,444

(22) Filed: Mar. 12, 2015

Related U.S. Application Data
(60) Provisional application No. 61/975,013, filed on Apr. 4, 2014.

(51) Int. Cl. H01M 4/62; H01M 4/04; H01M 10/0525

(52) U.S. Cl. CPC H01M 4/622; H01M 4/625; H01M 10/0525; H01M 4/0404

(57) ABSTRACT

An electrode comprising an aluminum or aluminum alloy current collector, a conductive interlayer disposed on the current collector and an electroactive material layer disposed on the conductive interlayer. The interlayer comprises an interlayer conductivity agent and an interlayer binding agent.

### FIELD OF THE INVENTION

Electrodes comprising a certain conductive interlayer between an electroactive material layer and an aluminum current collector.

### BACKGROUND OF THE INVENTION

Current collectors in the electrodes of secondary batteries, such as lithium ion batteries, are typically non-precious metal foils such as copper, aluminum, nickel and stainless steel foil. Copper is particularly advantageous as a current collector as it has the highest conductivity of the foils just mentioned and is usually the metal of choice for current collectors in negative electrodes, but is typically unstable at high potentials found in the positive electrode. Aluminum has the next highest conductivity and is usually the metal of choice as the current collector in positive electrodes, but is typically not used as a current collector in lithium ion battery negative electrodes because it alloys with lithium.

A conductive barrier layer (interlayer) between the current collector and the electroactive material can improve the performance of an electrode by reducing contact resistance, corrosion and/or increasing adhesion. The nature of these protective, conductive interlayers generally differs as the materials that are suited for copper are not necessarily suited for aluminum and materials which are stable under negative potential are not necessary stable under positive potential.

It is an object of this invention to provide an effective conductive interlayer for aluminum and aluminum alloy current collectors to improve the overall performance of batteries comprising electrodes with such interlayer/current collector combination.

### SUMMARY OF THE INVENTION

In one aspect, the present invention pertains to an electrode comprising: a) a current collector comprised of aluminum or aluminum alloy; b) a conductive interlayer disposed on the current collector wherein said interlayer comprises an interlayer conductivity agent and an interlayer binding agent comprising polyimide; and, c) an electroactive material layer disposed on the conductive interlayer.

In another aspect, the present invention pertains to a lithium ion battery comprising this electrode.

In yet another aspect, the present invention pertains to a process to make an electrode comprising: a) providing a current collector comprised of aluminum or aluminum alloy; b) disposing a conductive interlayer on the current collector wherein said interlayer comprises an interlayer conductivity agent and an interlayer binding agent comprising polyimide; and, c) disposing an electroactive material layer on the conductive interlayer.

The electrode of this invention advantageously exhibits lower contact resistance compared to a similar electrode without the prescribed conductive interlayer. Also, the interlayer, and ultimately the cathode active material layer, are well adhered to the current collector.

### BRIEF DESCRIPTION OF THE DRAWINGS

FIG. 1 depicts a partial cross-section of an electrode according to an embodiment of the present invention.

### DETAILED DESCRIPTION OF THE INVENTION

“Lithium ion battery” refers to a type of rechargeable battery in which lithium ions move from the anode to the cathode during discharge and from the cathode to the anode during charge.

“Anode” refers to the electrode of an electrochemical cell, at which oxidation occurs. In a galvanic cell, such as a battery, the anode is the negatively charged electrode. In a secondary (i.e. rechargeable) battery, the anode is the electrode at which oxidation occurs during discharge and reduction occurs during charging.

“Cathode” refers to the electrode of an electrochemical cell, at which reduction occurs. In a galvanic cell, such as a battery, the cathode is the positively charged electrode. In a secondary (i.e. rechargeable) battery, the cathode is the electrode at which reduction occurs during discharge and oxidation occurs during charging.

“Current collector” refers to a structural part of an electrode assembly whose primary purpose is to conduct electricity between the actual working part of the electrode and the terminals of an electrochemical cell. A current collector may, in general, be any one of various materials commonly used in the art, for example, a copper foil or an aluminum foil, but is not limited thereto.

The electrode prescribed herein comprises a current collector comprising, consisting essentially of, or consisting of, aluminum or aluminum alloy. For convenience, the prescribed current collector may be referred to simply as ‘aluminum’, but will be understood to also include aluminum alloys unless otherwise stated. The prescribed current collector can be any suitable size and shape, but is generally a thin foil. The surface of the prescribed current collector may comprise a native oxide layer (untreated) or the surface may be treated to remove the native oxide layer.

Disposed on the surface of the aluminum current collector is a conductive interlayer, said interlayer comprising interlayer conductivity agent and interlayer binding agent. The interlayer conductivity agent can be any suitable conductivity agent or combination of such agents. The interlayer binding agent comprises, consists essentially of, or consists of polyimide. In various embodiments, the weight percent of interlayer conductivity agent in the conductive interlayer can be at least 5 wt %, at least 10 wt %, at least 20 wt %, at least 40 wt %, at least 50 wt %, at least 60 wt %, at least 70 wt %, at least 75 wt %, at least 80 wt %, at least 85 wt %, and at least 90 wt % relative to the total weight of interlayer conductive agent and interlayer binding agent in the interlayer. In some embodiments, the weight percent of interlayer conductivity agent in the conductive interlayer is in the range of 10 wt % to 60 wt % based on the total weight of interlayer conductive agent and interlayer binding agent in the interlayer. In some embodiments, the weight percent of interlayer conductivity agent in the conductive interlayer is in the range of 15 wt % to 40 wt % based on the total weight of interlayer conductive agent and interlayer binding agent in the interlayer.

Suitable interlayer conductivity agents include electrically conductive carbon blacks, turbostratic carbons and graphitic carbons as well as conductive fibers such as carbon nanotubes or nanofibers and metal carbides and oxycarbides (based on, for example, W, Mo or B).

The polyimide of the interlayer binder is not limited and can be any suitable polyimide composition. In practice, the polyimide interlayer binder is formed from a precursor composition, polyamic acid, and cured (or “imidized”) in place on the current collector. The terms “precursor” or “polyamic acid” are used interchangeably.

In one embodiment, an interlayer conductivity agent and a polyimide interlayer binder precursor solution are slurried together and applied to an aluminum foil current collector surface. Application of the slurry can be by suitable method including, for example, spray coating, screen printing, coating with a doctor blade, gravure coating, dip coating, silk screening and the like. Once applied, the precursor is cured prior to disposition of the electroactive material layer on the conductive interlayer. The interlayer coating can be a continuous or discontinuous film. In some embodiments, ‘islands’ of interlayer conductivity agent and interlayer binder may exist.

The amount of interlayer is typically in a range of 0.01 mg to 1.0 mg of interlayer per cm² of current collector. In one embodiment, the amount of interlayer is in a range of 0.02 mg to 0.5 mg of interlayer per cm² of current collector. In another embodiment, the amount of interlayer is in a range of 0.02 mg to 0.1 mg of interlayer per cm² of current collector. In yet another embodiment, the amount of interlayer is in a range of 0.04 mg to 0.09 mg of interlayer per cm² of current collector.

The polyimide precursor solution can be in any fluid form, such as a slurry, dispersion, or solution. The precursor solution can comprise a solvent which can be any solvent that is inert to the polyamic acid, but is typically the solvent used in the preparation of the polyamic acid. Typical solvents are aprotic and include dimethylacetamide and n-methyl-2-pyrrolidone.

Imidization of the polyamic acid can be accomplished, for example, by dehydration at elevated temperature according to methods well known in the art. Imidization of the polyamic acid can also be accomplished by chemical conversion. For example, the polyamic acid which has mixed with a conductive component and coated onto to a aluminum current collector can be contacted (e.g. spray coated) with conversion chemicals, such as: (i) one or more dehydrating agents, such as, aliphatic acid anhydrides (acetic anhydride and so forth) and aromatic acid anhydrides; and (ii) one or more catalysts, such as, aliphatic tertiary amines (triethylamine and so forth), aromatic tertiary amines (dimethylaniline and so forth) and heterocyclic tertiary amines (pyridine, picoline, isoquinoilne and so forth). The anhydride dehydrating material is often used in a slight molar excess of the amount of amide acid groups in the co-polyamic acid. The amount of acetic anhydride used is typically about 2.0-3.0 moles per equivalent of co-polyamic acid. Generally, a comparable amount of tertiary amine catalyst is used.

Generally, the polyamic acid is completely or nearly completely imidized. In one embodiment, the polyamic acid is at least 80% imidized. In one embodiment the polyamic acid is at least 50% imidized.

Polyamic acid is a reaction product of a tetracarboxylic acid dianhydride and an organic diamine. In one embodiment the dianhydride is aromatic. In another embodiment the diamine is aromatic. in yet another embodiment both the dianhydride and the diamine are aromatic.

The polyamic acids can be prepared by any suitable method, such as those discussed in Polyimides (Encyclopedia of Polymer Science and Technology, R G Bryant, 2006, DOI: 10.1002/0471440264.pst272.pub2, John Wiley & Sons, Inc.). One method includes dissolving the diamine in a dry solvent and slowly adding the dianhydride under conditions of agitation and controlled temperature, and in a dry atmosphere, such as nitrogen.

Examples of suitable solvents include: sulfoxide solvents (dimethyl sulfoxide, diethyl sulfoxide and so forth), formamide solvents (N,N-dimethylformamide, N,N-diethylformamide and so forth), acetamide solvents (N,N-dimethylacetamide, N,N-diethylacetamide and so forth), pyrrolidone solvents (N-methyl-2-pyrrolidone, N-vinyl-2-pyrrolidone and so forth), phenol solvents (phenol, o-, m- or p-cresol, xylenol, halogenated phenols, catechol and so forth), hexamethylphosphoramide and gamma-butyrolactone. It is desirable to use one of these solvents or mixtures thereof. It is also possible to use combinations of these solvents with aromatic hydrocarbons such as xylene and toluene, or ether containing solvents like diglyme, propylene glycol methyl ether, propylene glycol, methyl ether acetate, tetrahydrofuran, and the like.

Suitable organic dianhydrides include, but are not limited to, pyromellitic dianhydride (PMDA); biphenyltetracarboxylic dianhydride (BPDA); 3,3′,4,4′-benzophenone tetracarboxylic dianhydride (BTDA); 2,3,6,7-naphthalene tetracarboxylic dianhydride; 3,3′,4,4′-tetracarboxybiphenyl dianhydride; 1,2,5,6-tetracarboxynaphthalene dianhydride; 2,2′,3,3′-tetracarboxybiphenyl dianhydride; 2,2-bis(3,4-dicarboxyphenyl) propane dianhydride; bis(3,4-dicarboxyphenyl) sulfone dianhydride; bis(3,4-dicarboxyphenyl) ether dianhydride; naphthalene-1,2,4,5-tetracarboxylic dianhydride; naphthalene-1,4,5,8-tetracarboxylic dianhydride; pyrazine-2,3,5,6-tetracarboxylic dianhydride; 2,2-bis(2,3-dicarboxyphenyl) propane dianhydride; 1,1-bis(2,3-dicarboxyphenyl) ethane dianhydride; 1,11-bis(3,4-dicarboxyphenyl) ethane dianhydride; bis(2,3-dicarboxyphenyl) methane dianhydride; bis(3,4-dicarboxyphenyl) methane dianhydride; benzene-1,2,3,4-tetracarboxylic dianhydride; 3,4,3′,4′-tetracarboxybenzophenone dianhydride; perylene-3,4,9,10-tetracarboxylic dianhydride; bis-(3,4-dicarboxyphenyl) ether tetracarboxylic dianhydride; 4,4′-oxydiphthalic anhydrid; 3,3′,4,4′-diphenyl sulfone tetracarboxylic dianhydride; 2,2-bis(3,4-dicarboxyphenyl) hexafluoropropane; Bisphenol A dianhydride (4,4′-(4,4′-isopropylidenediphenoxyl)bis(phthalic anhydride)); and mixtures thereof. In one embodiment the organic dianhydrides is pyromellitic dianhydride, 3,3′,4,4′-biphenyl tetracarboxylic dianhydride, 3,3′,4,4′-benzophenone tetracarboxylic dianhydride, 4,4′-oxydiphthalic anhydride, 3,3′,4,4′-diphenyl sulfone tetracarboxylic dianhydride, 2,2-bis(3,4-dicarboxyphenyl) hexafluoropropane, Bisphenol A dianhydride, or mixtures thereof.

Suitable organic diamines include, but are not limited to, 3,4′-oxydianiline, 1,3-bis-(4-aminophenoxy)benzene, 4,4′-oxydianiline (ODA), 1,4-diaminobenzene, 1,3-diaminobenzene, 2,2′-bis(trifluoromethyl)benzidene, 4,4′-diaminobiphenyl, 4,4′-diaminodiphenyl sulfide, 9,9′-bis(4-amino)fluorine, 1,3-bis(4-aminophenoxy)benzene (RODA), and 1,4 phenylenediamine (PDA); m-phenylenediamine; p-phenylenediamine; 4,4′-diaminodiphenyl propane; 4,4′-diaminodiphenyl methane benzidine; 4,4′-diaminodiphenyl sulfide; 4,4′-diaminodiphenyl sulfone; 4,4′-diaminodiphenyl ether; 1,5-diaminonaphthalene; 3,3′-dimethyl benzidine; 3,3′-dimethoxy benzidine; bis-(para-beta-amino-t-butylphenyl)ether; 1-isopropyl-2,4-m-phenylenediamine; m-xylylenediamine; p-xylylenediamine; di(paraminocyclohexyl) methane; hexamenthylenediamine; heptamethylenediamine; octamethylenediamine; decamethylenediamine; nonamethylenediamine; 4,4-dimethylheptamethyienedia-2,11-diaminododecane; 1,2-bis(3-aminopropoxyethane); 2,2-dimethylpropylenediamine; 3-methoxyhexamethylenediamine; 2,5-dimethyl hexamethylenediamine; 3-methylheptamethylenediamine; piperazine; 1,4-diamino cyclohexane; 1,12-diamino octadecane; 2,5-diamino-1,3,4-thiadiazole; 2,6-diaminoanthraquinone; 9,9′-bis(4-aminophenyl fluorene); p,p′-4,4 bis(aminophenoxy); 5.5′-diamino-2,2′-bipyridylsuifide; 2,4-diaminoisopropyl benzene; 1,3-diaminobenzene (MPD); 2,2′-bis(trifluoromethyl)benzidene; 4,4′-diaminobiphenyl; 4,4′-diaminodiphenyl sulfid; 9,9′-bis(4-amino)fluorine; and mixtures thereof. In one embodiment the orgnaic diamine is 3,4′-oxydianiline, 1,3-bis-(4-aminophenoxy)benzene, 4,4′-oxydianiline, 1,4-diaminobenzene, 1,3-diaminobenzene, 2,2′-bis(trifluoromethyl)benzidene, 4,4′-diaminobiphenyl, 4,4′-diaminodiphenyl sulfide, 9,9′-bis(4-amino)fluorine or mixtures thereof. In one embodiment the interlayer binding agent comprises polyimide derived from pyromellitic dianhydride (PMDA), and oxydianiline (ODA).

In some embodiments, the polyimide which comprises the interlayer binding agent is substantially insoluble in organic solvents. In one embodiment, the polyimide which comprises the interlayer binding agent is substantially insoluble in N-methylpyrrolidone (NMP). In some embodiments the polyimide which comprises the interlayer binding agent is less than 1 wt %, less than 0.1 wt % or less than 0.05 wt % soluble in NMP.

Numerous embodiments of formation are possible, such as: (a) a method wherein the diamine components and dianhydride components are preliminarily mixed together and then the mixture is added in portions to a solvent while stirring, (b) a method wherein a solvent is added to a stirring mixture of diamine and dianhydride components, (c) a method wherein diamines are exclusively dissolved in a solvent and then dianhydrides are added thereto, (d) a method wherein the dianhydride components are exclusively dissolved in a solvent and then amine components are added thereto, (e) a method wherein the diamine components and the dianhydride components are separately dissolved in solvents and then these solutions are mixed in a reactor, (f) a method wherein the polyamic acid with excessive amine component and another polyamic acid with excessive dianhydride component are preliminarily formed and then reacted with each other in a reactor, particularly in such a way as to create a non-random or block copolymer, and (g) a method wherein a specific portion of the amine components and the dianhydride components are first reacted and then the residual diamine components are reacted, or vice versa, (h) a method wherein the components are added in part or in whole in any order to either part or whole of the solvent, also where part or all of any component can be added as a solution in part or all of the solvent, and (i) a method of first reacting one of the dianhydride components with one of the diamine components giving a first polyamic acid, then reacting the other dianhydride component with the other amine component to give a second polyamic acid, and then combining the polyamic acids in any one of a number of ways prior to film or fiber formation.

The temperature of the reaction is usually from about −30° C. to about 100° C., or about 0 to about 100° C., or about 10° C. to about 40° C. Typically, the reaction is carried out at room temperature.

In one embodiment, the polyamic acid described herein has an anhydride to amine ratio between about 0.96:1 and 1.10:1. In another embodiments, the anhydride to amine ratio is between about 0.985:1 and 1.10:1; between about 0.990:1 and 1.05:1; between about 0.990:1 and 1.01:1; and, between about 1.01:1 and 1.03:1. The anhydride to amine ratio is the molar ratio of the repeating units that are derived from the anhydride component and the repeating units that are derived from the diamine component in the polyamic acid, and is calculated from the starting reagents.

Polyimide precursor is readily available from commercial sources well known to those skilled in the art, for example, HD MicroSystems, Parlin, N.J.

The electrode comprises an electroactive material layer disposed on the conductive interlayer. Typically, the electrode of the present invention will be used as the positive electrode and the electroactive material layer disposed on the conductive interlayer will be a cathode-active material layer.

The electroactive material layer conductivity agent provides conductivity to the electrode and may be any one of various materials that do not cause any deleterious effects and that conduct electrons. Examples of the conductivity agent include a carbonaceous material, such as natural graphite, artificial graphite, flaky graphite, carbon black, acetylene black, ketjen black, denka black, carbon fiber; a metallic material, such as copper powder or fiber, nickel powder or fiber, aluminum powder or fiber, or silver powder or fiber; a conductive polymer such as a polyphenylene derivative, and mixtures thereof.

The electroactive material layer binder may allow active material particles to be attached to each other and the electro-active material to be attached to the interlayer/current collector. Non-limiting examples of the binder include polyvinylalcohol, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, epoxy resin, nylon, carboxymethyl cellulose, ethylene-propylene-diene terpolymer, poly(vinylidene fluoride-co-hexafluoropropylene, and a mixture thereof. For example, the binder may be polyvinylidene fluoride (PVDF). The electroactive material layer binder will typically be present in an amount of from 5 wt % to 10 wt % based on the weight of electroactive material. In one embodiment, the electroactive material layer binder is other than the polyimide species comprising the interlayer binding agent.

The electroactive material layer is commonly formed from a paste. The solvent used to make the electrode paste can be any one of various solvents commonly used for such purpose. Examples of such solvent include an acyclic carbonate, such as dimethyl carbonate, ethylmethyl carbonate. diethyl carbonate, or dipropyl carbonate, a cyclic carbonate, such as dimethoxyethane, diethoxyethane, a fatty acid ester derivative, ethylene carbonate, propylene carbonate, or butylene carbonate, gamma-butyrolactone, N-methylpyrrolidone (NMP), acetone, or water. The solvent may also be a combination of two or more of these. The solvent is removed after the electrode paste is applied in the desired form.

Suitable cathode materials for a lithium ion battery include, for example, electroactive compounds comprising lithium and transition metals, such as LicoO₂, LiNiO₂, LiMn₂O₄, LiCo_{0.2}Ni_{0.2}O₂ or LiV₃O₈;

LiₐCoG_{b}O₂ (0.90≦a≦1.8, and 0.001≦b≦0.1);

LiₐNi_{b}Mn_{c}Co_{d}RₑO_{2-f}Z_{f} where 0.8≦a≦1.2, 0.1≦b≦0.5, 0.2≦c≦0.7, 0.05≦d≦0.4, 0≦e≦0.2, b+c+d+e is about 1, and 0≦f≦0.08;

LiₐA_{1-b},R_{b}D₂ (0.90≦a≦1.8 and 0≦b≦0.5);

LiₐE_{1-b}R_{b}O_{2-c}D_{c} (0.9≦a≦1.8, 0≦b≦0.5 and 0≦c≦0.05);

LiₐNi_{1-b-c}Co_{b}R_{c}O_{2-d}Z_{d} where 0.9≦a≦1.8, 0≦b≦0.4, 0≦c≦0.05, and 0≦d≦0.05;

Li_{1+z}Ni_{1-x-y}CoₓAl_{y}O₂ where 0<x<0.3, 0<y<0.1, and 0<z<0.06;

LiNi_{0.5}Mn_{1.5}O₄; LiFePO₄, LiMnPO₄, LiCoPO₄, and LiVPO₄F.

In the above chemical formulas A is Ni, Co, Mn, or a combination thereof; D is O, F, S, P, or a combination thereof; E is Co, Mn, or a combination thereof; G is Al, Cr, Mn, Fe, Mg, La, Ce, Sr, V, or a combination thereof, R is Al, Ni, Co, Mn, Cr, Fe, Mg, Sr, V, Zr, Ti, a rare earth element, or a combination thereof; Z is F, S, P, or a combination thereof. Suitable cathodes include those disclosed in U.S. Pat. Nos. 5,962,166, 6,680,145, 6,964,828, 7,026,070, 7,078,128, 7,303,840, 7,381,496, 7,468,223, 7,541,114, 7,718,319, 7,981,544, 8,389,160, 8,394,534, and 8,535,832, and the references therein. By “rare earth element” is meant the lanthanide elements from La to Lu, and Y and Sc.

Another suitable cathode-active material is a lithium-containing manganese composite oxide having a spinel structure as an electro-active cathode material. A lithium-containing manganese composite oxide suitable for use herein comprises oxides of the formula LiₓNi_{y}M_{z}Mn_{2-y-z}O_{4-d}, wherein x is 0.03 to 1.0; x changes in accordance with release and uptake of lithium ions and electrons during charge and discharge; y is 0.3 to 0.6; M comprises one or more of Cr, Fe, Co, Li, Al, Ga, Nb, Mo, Ti, Zr, Mg, Zn, V, and Cu; z is 0.01 to 0.18; and d is 0 to 0.3. In one embodiment in the above formula, y is 0.38 to 0.48, z is 0.03 to 0.12, and d is 0 to 0.1. In one embodiment in the above formula, M is one or more of Li, Cr, Fe, Co and Ga. Stabilized manganese cathodes may also comprise spinel-layered composites which contain a manganese-containing spinel component and a lithium rich layered structure, as described in U.S. Pat. No. 7,303,840.

Other suitable cathode-active materials include layered oxides such as LiCoO₂ or LiNiₓMn_{y}Co_{z}O₂ where x+y+z is about 1, that can be charged to cathode potentials higher than the standard 4.1 to 4.25 V range in order to access higher capacity. Other examples are layered-layered high-capacity oxygen-release cathodes such as those described in U.S. Pat. No. 7,468,223 charged to upper charging voltages above 4.5 V. Suitable anode-active materials include, for example, lithiated carbon; lithium alloys such as lithium-aluminum alloy, lithium-lead alloy, lithium-silicon alloy, lithium-tin alloy and the like; carbon materials such as graphite and mesocarbon microbeads (MCMB); phosphorus-containing materials such as black phosphorus, MnP₄ and CoP₃; metal oxides such as SnO₂, SnO and TiO₂; and lithium titanates such as Li₄Ti₅O₁₂ and LiTi₂O₄. In one embodiment, a desirable anode-active material includes lithium titanate or graphite.

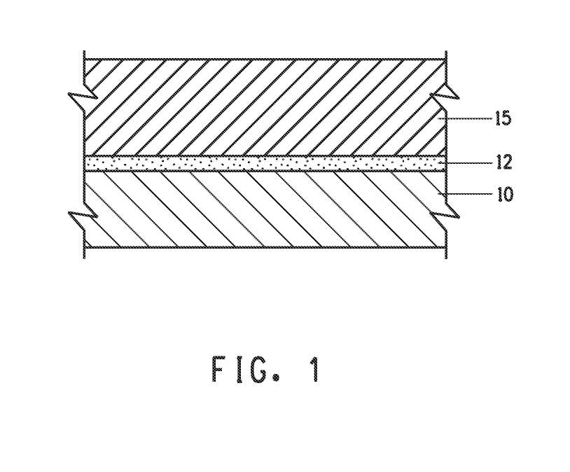

Referring to FIG. 1, there is depicted a partial cross-sectional view of an electrode according to one embodiment wherein an interlayer, 12, is disposed on an aluminum current collector, 10, and an electroactive material layer, 15, is disposed on the interlayer.

The present invention also pertains to the use of the inventive electrode in electrochemical cells such as lithium-ion batteries. The design and constituent components of electrochemical cells, lithium-ion batteries, are generally well known to those skilled in the art.

The “separator” is porous and serves to prevent short circuiting between the anode and the cathode of an electrochemical cell. The porous separator typically consists of a single-ply or multi-ply sheet of a microporous polymer such as polyethylene, polypropylene, polyamide or polyimide, or a combination thereof. The pore size of the porous separator is sufficiently large to permit transport of ions to provide ionically conductive contact between the anode and cathode, but small enough to prevent contact of the anode and cathode either directly or from particle penetration or dendrites which can from on the anode and cathode. Examples of porous separators suitable for use herein are disclosed in U.S. Patent Application Publication No. 2012/0149852.

“Electrolyte composition” as used herein, refers to a chemical composition suitable for use as an electrolyte in an electrochemical cell. An electrolyte composition typically comprises at least one solvent and at least one electrolyte salt.

“Electrolyte salt” as used herein, refers to an ionic salt that is at least partially soluble in the solvent of the electrolyte composition and that at least partially dissociates into ions in the solvent of the electrolyte composition to form a conductive electrolyte composition.

Typically, the electrolyte solvent comprises one or more alkyl carbonates including, for example, any one or a mixture of ethylene carbonate (EC), ethyl methyl carbonate (EMC) and dimethyl carbonate (DMC).

Suitable solvents for electrolyte compositions can also include fluorinated acyclic carboxylic acid esters, represented by the formula R¹—COO—R², where R¹ and R² independently represent an alkyl group, the sum of carbon atoms in R¹ and R² is 2 to 7, at least two hydrogens in R¹ and/or R² are replaced by fluorines and neither R¹ nor R² contains a FCH₂ or FCH group. Examples of suitable fluorinated acyclic carboxylic acid esters include without limitation CH₃—COO—CH₂CF₂H (2,2-difluoroethyl acetate, CAS No. 1550-44-3), CH₃—COO—CH₂CF₃ (2,2,2-trifluoroethyl acetate, CAS No. 406-95-1), CH₃CH₂—COO—CH₂CF₂H (2,2-difluoroethyl propionate, CAS No. 1133129-90-4), CH₃—COO—CH₂CH₂CF₂H (3,3-difluoropropyl acetate), CH₃CH₂—COO—CH₂CH₂CF₂H (3,3-difluoropropyl propionate), and HCF₂—CH₂—CH₂—COO—CH₂CH₃ (ethyl 4,4-difluorobutanoate, CAS No. 1240725-43-2). In one embodiment, the fluorinated acyclic carboxylic acid ester is 2,2-difluoroethyl acetate (CH₃—COO—CH₂CF₂H).

Other suitable fluorinated acyclic carbonates are represented by the formula R³—OCOO—R⁴, where R³ and R⁴ independently represent an alkyl group, the sum of carbon atoms in R³ and R⁴ is 2 to 7, at least two hydrogens in R³ and/or R⁴ are replaced by fluorines and neither R³ nor R⁴ contains a FCH₂ or FCH group. Examples of suitable fluorinated acyclic carbonates include without limitation CH₃—OC(O)O—CH₂CF₂H (methyl 2,2-difluoroethyl carbonate, CAS No. 916678-13-2), CH₃—OC(O)O—CH₂CF₃(methyl 2,2,2-trifluoroethyl carbonate, CAS No. 156783-95-8),

CH3-OC(O)O—CH₂CF₂CF₂H (methyl 2,2,3,3-tetrafluoropropyl carbonate, CAS No. 156783-98-1), HCF₂CH₂—OCOO—CH₂CH₃ (ethyl 2,2-difluoroethyl carbonate, CAS No. 916678-14-3), and CF₃CH₂—OCOO—CH₂CH₃ (ethyl 2,2,2-trifluoroethyl carbonate, CAS No. 156783-96-9).

Other suitable fluorinated acyclic ethers are represented by the formula: R⁵—O—R⁶, where R⁵ and R⁶ independently represent an alkyl group, the sum of carbon atoms in R⁵ and R⁶ is 2 to 7, at least two hydrogens in R⁵ and/or R⁶ are replaced by fluorines and neither R⁵ nor R⁶ contains a FCH₂ or FCH group. Examples of suitable fluorinated acyclic ethers include without limitation HCF₂CF₂CH₂—O—CF₂CF₂H (CAS No. 16627-68-2) and HCF₂CH₂—O—CF₂CF₂H (CAS No. 50807-77-7).

A mixture of two or more of these fluorinated acyclic carboxylic acid ester, fluorinated acyclic carbonate, and/or fluorinated acyclic ether solvents may also be used. Other suitable mixtures can include anhydrides. One suitable electrolyte solvent mixture includes a fluorinated acyclic carboxylic acid ester, ethylene carbonate, and maleic anhydride, such as 2,2-difluoroethey acetate, ethylene carbonate, and maleic anhydride. The electrolyte mixture may additionally comprise lithium bis(oxalate) borate and lithium difluoro(oxalate)borate. The electrolyte composition can comprise about 61% 2,2-difluoroethyl acetate, about 26% ethylene carbonate, and about 1% maleic anhydride by weight of the total electrolyte composition.

The electrolyte compositions described herein can also contain at least one electrolyte salt. Suitable electrolyte salts include without limitation
lithium hexafluorophosphate (LiPF₆),
lithium tris(pentafluoroethyl)trifluorophosphate (LiPF₃(C₂F₅)₃),
lithium bis(trifluoromethanesulfonyl)imide,
lithium bis(perfluoroethanesulfonyl)imide,
lithium (fluorosulfonyl) (nonafluorobutanesulfonyl)imide,
lithium bis(fluorosulfonyl)imide,
lithium tetrafluoroborate,
lithium perchlorate,
lithium hexafluoroarsenate,
lithium trifluoromethanesulfonate,
lithium tris(trifluoromethanesulfonyl)methide,
lithium bis(oxalato)borate,
lithium difluoro(oxalato)borate,
Li₂B₁₂F₁₂₋ₓHₓ where x is equal to 0 to 8, and
mixtures of lithium fluoride and anion receptors such as B(OC₆F₅)₃.

Mixtures of two or more of these or comparable electrolyte salts may also be used. A suitable electrolyte salt is lithium hexafluorophosphate. The electrolyte salt can be present in the electrolyte composition in an amount of about 0.2 to about 2.0 M, or about 0.3 to about 1.5 M, or about 0.5 to about 1.2 M.

The optimum range of salt and solvent concentrations in the electrolyte may vary according to specific materials being employed and the anticipated conditions of use, for example, according to the intended operating temperature. In one embodiment, the solvent is 20 to 40 parts by volume of ethylene carbonate and 60 to 80 parts by volume of ethyl methyl carbonate, and the salt is LiPF₆.

Alternatively, the electrolyte may comprise a lithium salt such as, lithium hexafluoroarsenate, lithium bis-trifluoromethyl sulfonamide, lithium bis(oxalate)boronate, lithium difluorooxalatoboronate, or the Li⁺ salt of polyfluorinated cluster anions, or combinations of these. Alternatively, the electrolyte may comprise a solvent, such as, propylene carbonate, esters, ethers, or trimethylsilane derivatives of ethylene glycol or poly(ethylene glycols) or combinations of these. Additionally, the electrolyte may contain various additives known to enhance the performance or stability of Li-ion batteries, as reviewed for example by K. Xu in Chem. Rev., 104, 4303 (2004), and S. S. Zhang in J. Power Sources, 162, 1379 (2006).

The housing of the electrochemical cell may be any suitable container to house the electrochemical cell components described above. Such a container may be fabricated in the shape of a cylindrical battery, a rectangular battery, a coin-type battery, or a pouch-type battery; and according to a size, a bulky battery and a thin-film type battery. Methods of manufacturing the lithium secondary batteries as described above are widely known in the art.

The electrochemical cell or lithium ion battery disclosed herein may be used for grid storage or as a power source in various electronically-powered or -assisted devices (“electronic device”) such as a transportation device (including a motor vehicle, automobile, truck, bus or airplane), a computer, a telecommunications device, a camera, a radio or a power tool.

It is understood that the embodiments described herein disclose only illustrative but not exhaustive examples of the invention set forth.

### EXAMPLES

### Preparation of Electroactive Cathode Material

397.2 g of MnO₂ (Alfa Aesar 42250), 101.2 g NiO (Alfa Aesar 12359) 11.9 g Fe₂O₃ (Aldrich 310030) and 117.7 g of Li₂CO₃ (Alfa Aesar 13418) were added to a UHMWPE vibratory milling pot, along with 5 kg of 10 mm cylinder yttria-stabilized zirconia media and 625 g of acetone. The pot was sealed and low amplitude vibratory milled on a Sweco mill for 40.5 hours. Then 50 g of LiCl (Alfa Aesar 36217) was added to the pot and it was milled for an additional 3 hours. The mixed powder was separated from the acetone by vacuum filtration through a nylon membrane and dried. The dry cake was then placed in a poly bag and tapped with a rubber mallet to break up or pulverize any large agglomerates. The resulting powder was packed into a 750 mL alumina tray, covered with an alumina plate and fired in a box furnace with the following heating protocol: 25° C. to 900° C. in 6 hours; dwell at 900° C. for 6 hours; cool to 100° C. in 15 hours.

Once the fired material was at room temperature, it was again placed in a poly bag and tapped with a rubber mallet. Then it was transferred to a 1 gallon poly jug and slurried with 1 L of deionized water. The jug was placed in an ultrasonic bath for 15 minutes to aid dissolution of LiCl. Following this procedure, material was filtered using a 3 L fine glass frit Buchner funnel, and rinsed with 21 L of deionized water to remove any residual lithium chloride. The filter cake was rinsed with 150 mL of isopropyl alcohol (IPA) to remove the water, and partially dried. The filter cake was transferred to a 1 gallon poly bottle with 500 g of IPA, and 2 kg of 10 mm YTZ cylinder media for particle size reduction. The bottle was tumbled for 90 minutes on a set of rollers, then filtered through the same glass Buchner funnel to remove the IPA. Finally the powder was dried in a vacuum oven overnight at 70° C. The 0.03 Lᵢ₂MnO₃-0.97 LiMn_{1.5}Ni_{0.45}Fe_{0.05}O₄ layered spinel thus prepared was used as the cathode active material for the examples herein.

### Example 1

### Electrode with Polyimide/Carbon Interlayer

<Preparation of the Carbon/Polyimide Interlayer on Aluminum Foil.>

To prepare the polyamic acid, a prepolymer was first prepared. 20.6 wt % of PMDA:ODA prepolymer was prepared using a stoichiometry of 0.98:1 PMDA/ODA (pyromellitic dianhydride//ODA (4,4′-diaminodiphenyl ether) prepolymer). This was prepared by dissolving ODA in N-methylpyrrolidone (NMP) over the course of approximately 45 minutes at room temperature with gentle agitation. PMDA powder was slowly added (in small aliquots) to the mixture to control any temperature rise in the solution; the addition of the PMDA was performed over approximately two hours. The final concentration of the polyamic acid was 20.6 wt % and the molar ratio of the anhydride to the amine component was approximately 0.98:1.

In a separate container, a 6 wt % solution of pyromellitic anhydride (PMDA) was prepared by combining 1.00 g of PMDA (Aldrich 412287, Allentown, Pa.) and 15.67 g of NMP (N-methylpyrrolidone). 4.0 grams of the PMDA solution was slowly added to the prepolymer and the viscosity was increased to approximately 90,000 poise (as measured by a Brookfield viscometer—#6 spindle). This resulted in a finished prepolymer solution in which the calculated final PMDA:ODA ratio was 1.01:1.

The finished prepolymer, 5.196 grams, was then diluted with 15.09 grams of NMP to create a 5 wt % solution. In a vial, 16.2342 grams of the diluted finished prepolymer solution was added to 0.1838 grams of TimCal Super C-65 carbon black. This was further diluted with 9.561 grams of NMP for a final solids content of 3.4 wt %, with a 2.72 prepolymer:carbon ratio. A Paasche VL #3 Airbrush sprayer (Paasche Airbrush Company, Chicago, Ill.) was used to spray this material onto the aluminum foil (25 μm thick, 1145-0, Allfoils, Brooklyn Heights, Ohio). The foil was weighed prior to spraying to identify the necessary coating to reach a desired density of 0.06 mg/cm². The foil was then smoothed onto a glass plate, and sprayed by hand with the airbrush until coated. The foil was then dried at 125° C. on a hot plate, and measured to ensure that the desired density was reached. The foil was found to be coated with 0.062 mg/cm² of the polyamic acid. Once the foil was dried and at the desired coating, the foil was imidized at 400° C. the following imidization procedure: 40° C. to 125° C. (ramp at 4° C./min); 125° C. to 125° C. (soak 30 min); 125° C. to 250° C. (ramp at 4° C./min); 250° C. to 250° C. (soak 30 min); 250° C. to 400° C. (ramp at 5° C./min); 400° C. to 400° C. (soak 20 min). The carbon/polyimide conductive interlayer was thus formed on the aluminum foil.

<Preparation of the Cathode Material Layer>

Cathode paste was prepared as follows. Polyvinylidene fluoride was dissolved in NMP to 5.5% PVDF (Solef 5130, Solvay, Brussels, Belgium). Carbon black (Denka uncompressed, DENKA Corp., Japan), 0.3420 g, PVDF solution, 6.2174 g, and 1.8588 g NMP were combined in a plastic THINKy vial and centrifugally mixed (ARE-310, Thinky USA, Inc., Laguna Hills, Calif.) two times, for 60 s at 2000 rpm each time. The cathode active powder, 6.1552 g, and additional NMP, 0.5171 g, were then added to the vial and the vial was centrifugally mixed two times (2×1 min at 2000 rpm). The vial was then treated with a sonic horn for 3 seconds. The final paste contained 44.7% solids having a ratio of 90:5:5, cathode active powder:PVDF:carbon black.

The cathode paste was cast onto the treated side of the carbon/polyimide-treated aluminum current collector. The operation was performed by hand using a Bird Film Applicator (BFA) with a 6 mil opening plus 2 mil tape for a total of an 8 mil opening. The current collector was held in place with a vacuum plate. The electrodes were dried for 30 min at 90° C. in a mechanical convection oven (model FDL-115, Binder Inc., Great River, N.Y.). The resulting 51-mm wide cathodes were placed between 125 mm thick brass sheets and passed through a calender three times using 100 mm diameter steel rolls at 125° C. with nip forces increasing in each of the passes, at pressures of 310, 410, and 510 kg-force. Loadings of cathode active material were 9 to 10 mg/cm².

<Contact Impedance Measurement>

The resistance of the contact between the current collector and the electrode was measured as follows. A lower contact was formed from a 12.7 mm diameter×13 mm stainless steel (SS) rod and an upper contact was formed from a 6.35 mm diameter×25 mm SS rod. The ends of the contact rods were polished and plated with gold. Two disks were punched from the electrode to be measured, a 6.35 mm dia. disk and a 9.5 mm dia. disk. A stack was formed, which for a cathode coated on aluminum foil current collector was: lower contact|Al|cathode|cathode|Al|upper contact, with the 9.5 mm diameter Al|cathode disk touching the lower contact. The use of different dia. punches minimized the risk of aluminum burrs at the edges shorting together. The stack was assembled and held in place within a 46 mm×21 mm×15.5 mm fixture block of Macor® machinable glass ceramic rod (Corning Inc., Corning, N.Y.) that had a 12.7 mm diameter hole drilled into the bottom of the block to accept the lower contact and a concentric 6.4 mm diameter hole drilled into the top of the block to accept the upper contact. The fixture was mounted within a test stand (Mark-10 Industries ES20) to apply compressive force between the upper and lower contacts, and the force was measured with a force gage (Mark-10 Industries MG10, 10 lb capacity×0.01 lb resolution). Forces of 10 or 27 N were applied over the 0.317 cm² area of the smaller electrode, giving pressures of 320 or 850 kPa. The real part of the AC impedance between the two contacts of the fixture, Rₘ, was measured in the frequency range of 1 to 100 Hz using a potentiostat/frequency response analyzer (PC4/750™ with EIS software, Gamry Instruments, Warminster, Pa.). In this range the imaginary parts of the impedance were much lower than the real parts, and the value of the resistance was almost independent of frequency.

The resistance of the above stack is the sum of resistances arising from several materials and interfaces:
a) the wires connecting to the SS rods;
b) bulk resistivity of the SS rods;
c) two SS|Au or SS|Ni|Au interfaces (SS may be Ni-plated before Au plating);
d) two Au|Al interfaces;
e) bulk resistance within the two Al foils;
f) two Al|cathode interfaces;
g) bulk resistance within the two cathodes; and
h) one cathode|cathode interface.

When two pieces of uncoated aluminum foil, with their shiny sides touching each other, were placed in the fixture, lower contact|Al|Al|upper contact, the resistance @850 kPa was 0.068 ohm. This was the sum of the resistances a)-e), plus i) one Al|Al interface. When using two aluminum foils coated with cathodes, the resistance @850 kPa was typically in the range of 0.7-10 ohm. Thus the resistance of a)-e) was negligible relative to the resistance when the cathodes were present. The bulk electronic conductivity of the cathodes used here was typically in the range of 0.25-0.5 S/cm, and their thickness was typically 50 micrometers (microns). The upper value of resistance from the bulk of the cathodes was 2 cathodes×0.0050 cm thick/[0.25 S/cm conductivity×0.317 cm²]=0.13 ohm.

Though not negligible, this value is still quite smaller than the total observed values. In another experiment, silver paste was introduced between the two cathodes: lower contact|Al|cathode|silver paste|cathode|Al|upper contact; the resistance was the same (within 0.02 ohm) as that without the silver paste. This showed that the contribution h) of interface cathode|cathode was negligible. Thus the resistance measured here was dominated by f) the two interfaces between the aluminum foil and the cathodes. In order to compare to the values of impedances measured in electrochemical cells using a single cathode, the measured resistance Rm was divided by 2 to give the contribution of only one Al|cathode interface, and normalized for an area of 1 cm²: contact resistance Rc (ohm-cm²)=0.317 cm²×Rₘ/2.

Tested in this way, the mean contact impedance of the Example 1 electrode was 0.41 ohm-cm² at 848 kPa.

### Example A (Control)

### Electrode with No Interlayer on the Current Collector

As a control, an electrode was prepared as in Example 1 except that the current collector had no conductive interlayer; the cathode active material layer was formed directly to the aluminum current collector surface. The contact resistance of the Control electrode was measured as described in Example 1 and the mean contact impedance was 4.80 ohm-cm² at 848 kPa pressure.

The substantially lower contact resistance of the Example 1 electrode relative to the control electrode demonstrates a benefit of the conductive interlayer.

### Example B (Comparative)

### Polyimide Interlayer without Carbon Black

For comparison, an electrode was prepared as in Example 1 except that the interlayer on the aluminum current collector consisted only of polyimide, no conductive carbon was added. The contact resistance of the Comparative B electrode was measured as described in Example 1 and the mean contact impedance was 18.21 ohm-cm² at 848 kPa pressure.

The substantially higher contact resistance of the Comparative B electrode relative to the Control demonstrates importance of the conductivity agent (carbon black) in the carbon/polyimide interlayer.

What is claimed is:

1. An electrode comprising:
a) a current collector comprised of aluminum or aluminum alloy;
b) a conductive interlayer disposed on the current collector wherein said interlayer comprises an interlayer conductivity agent and an interlayer binding agent comprising polyimide; and,
c) an electroactive material layer disposed on the conductive interlayer.

2. The electrode of claim 1 wherein the interlayer conductivity agent is selected from electrically conductive carbon blacks, turbostratic carbons and graphitic carbons.

3. The electrode of claim 1 wherein the interlayer binding agent comprising polyimide is derived from pyromellitic dianhydride (PMDA) oxydianiline (ODA).

4. The electrode of claim 1 wherein the interlayer conductivity agent is at least 10 weight % of the conductive interlayer based on the total weight of interlayer conductivity agent and interlayer binding agent.

5. The electrode of claim 1 wherein the interlayer binding agent consists essentially of polyimide.

6. The electrode of claim 1 wherein the polyimide comprising the interlayer binding agent is substantially insoluble in N-methylpyrrolidone.

7. A lithium ion battery comprising an electrode according to claim 1

8. A lithium ion battery comprising a cathode and anode wherein the cathode is an electrode according to claim 1.

9. A process to make an electrode comprising:
a) providing a current collector comprised of aluminum or aluminum alloy;
b) disposing a conductive interlayer on the current collector wherein said interlayer comprises an interlayer conductivity agent and an interlayer binding agent comprising polyimide; and,
c) disposing an electroactive material layer on the conductive interlayer.
